(19) United States
(12) Patent Application Publication
(10) Pub. No.: US 2012/0197658 A1
(43) Pub. Date: Aug. 2, 2012

(54) METHODS AND SYSTEMS FOR ELECTRONIC SCRIPT USAGE

(75) Inventor: R. Jamie Spriggs, Baltimore, MD (US)

(73) Assignee: ConnectYourCare Company, LLC, Hunt Valley, MD (US)

(21) Appl. No.: 13/324,228

(22) Filed: Dec. 13, 2011

Related U.S. Application Data
(60) Provisional application No. 61/438,632, filed on Feb. 1, 2011.

(51) Int. Cl. G06Q 50/22

(52) U.S. Cl. 705/2

(57) ABSTRACT

Methods and systems for electronic script usage are described. In one embodiment, questionnaire data associated with an over-the-counter medication is selected. A questionnaire display including a plurality of questions based on the questionnaire data is generated. Questionnaire response data is received. A prescriber request is transmitted to a prescriber device. The prescriber request is based on the questionnaire response data. The prescriber device is associated with a prescriber. A prescriber response is received in response to transmission of the prescriber request. An electronic script associated with the over-the-counter medication is rendered in response to receipt of the prescriber response. Additional methods and systems are disclosed.

### CROSS-REFERENCE TO A RELATED APPLICATION

The present application claims the benefit of U.S. provisional patent application Ser. No. 61/438,632, entitled “Methods and Systems for Electronic Script Usage” filed on 1 Feb. 2011, the entire disclosure of which is incorporated herein by reference.

### FIELD

The field relates to electronic script usage, and more particularly to the rendering of electronic scripts for over-the-counter medications.

### BACKGROUND

In order for over-the-counter medications to be valid expenditures of tax-advantaged accounts, it may be required that prescriptions be issued for such over-the-counter medications. To the extent that prescriptions are required, participants having tax-advantaged accounts may be forced to undergo the time-consuming process of obtaining such prescriptions from their physicians via traditional means (e.g., calling the physician to request that the script be directed to the participant's pharmacy). This process may not provide the participant with a level of convenience sufficient to incentivize the participant to utilize its tax-advantaged account.

### BRIEF DESCRIPTION OF THE DRAWINGS

FIG. 1 is a block diagram of an example system, according to an example embodiment;

FIG. 2 illustrates an example script rendering device that may be deployed in the system of FIG. 1, according to an example embodiment;

FIG. 3 illustrates an example account management device that may be deployed in the system of FIG. 1, according to an example embodiment;

FIG. 4 illustrates an example medication distributor device that may be deployed in the system of FIG. 1, according to an example embodiment;

FIG. 5 illustrates an example prescriber device that may be deployed in the system of FIG. 1, according to an example embodiment;

FIG. 6 is a block diagram of a script rendering subsystem that may be deployed within the script rendering device of FIG. 2, according to an example embodiment;

FIG. 7 is a block diagram of an account management subsystem that may be deployed within the account management device of FIG. 3, according to an example embodiment;

FIG. 8 is a block diagram of a medication processing subsystem that may be deployed within the medication distributor device of FIG. 4, according to an example embodiment;

FIG. 9 is a block diagram of a prescriber subsystem that may be deployed within the prescriber device of FIG. 5, according to an example embodiment;

FIG. 10 is an example process flow illustrating a method for electronic script rendering, according to an example embodiment;

FIG. 11 is an example process flow illustrating a method for obtaining an electronic script, according to an example embodiment;

FIG. 12 is an example process flow illustrating a method for account management, according to an example embodiment;

FIG. 13 is an example process flow illustrating a method for order fulfillment, according to an example embodiment;

FIG. 14 is an example process flow illustrating a method for receiving a prescriber approval, according to an example embodiment; and

FIG. 15 is a block diagram of a machine in the example form of a computer system within which a set of instructions for causing the machine to perform any one or more of the methodologies discussed herein may be executed.

### DETAILED DESCRIPTION

Example methods and systems for electronic script usage are described. In the following description, for purposes of explanation, numerous specific details are set forth in order to provide a thorough understanding of example embodiments. It will be evident, however, to one of ordinary skill in the art that embodiments of the invention may be practiced without these specific details.

The methods and systems may be used to enable a participant to purchase over-the-counter medications from a tax-advantaged account. Examples of these medications include acid controllers, allergy and sinus medicine, anti-diarrheal medicine, anti-gas medicine, anti-itch and insect bite medicine, baby rash ointments and creams, cold sore remedies, cough, cold, and flu medicine, digestive aids, feminine anti-fungal/anti-itch medicine, hemorrhoid medicine, laxatives, motion sickness medicine, pain relievers, respiratory treatments, sleep aids and sedatives, stomach remedies, and the like. The methods and systems may provide an easier and more convenient manner to obtain a script for an over-the-counter medicine to enable tax-free spending.

In some embodiments, obtaining the script electronically may add a tremendous amount of convenience to the script process and may enhance the value of health accounts. Without the methods and systems, participants (e.g., persons) may be less likely to obtain a health account and/or may reduce the amount of funds committed to a health account.

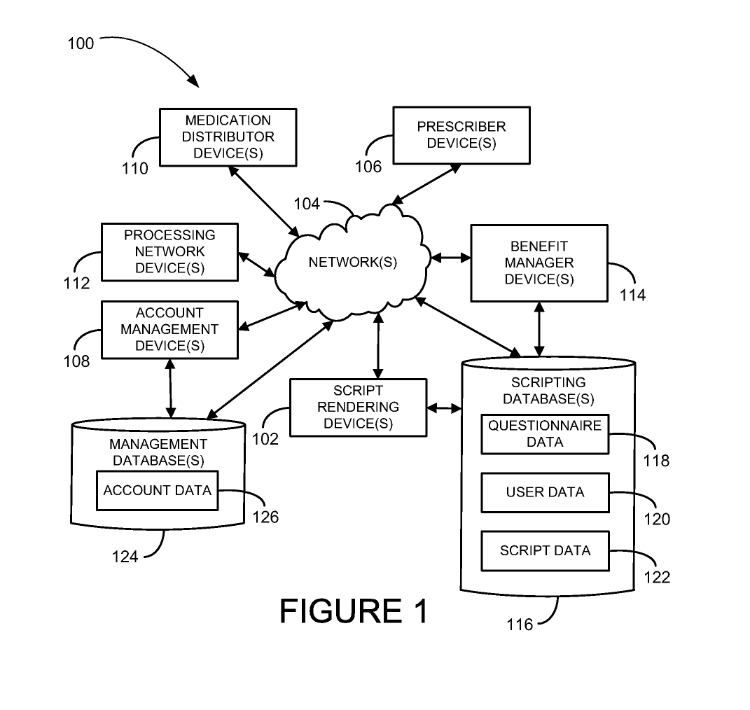

FIG. 1 is a block diagram of an example system 100, according to an example embodiment. The system 100 includes a script rendering device 102 in communication over a network 104 with a prescriber device 106.

The script rendering device 102 is a device operated by an entity that enables participants to obtain an electronic script for an over-the-counter medication. In general, an electronic script of an over-the-counter medication is rendered or generated on the script rendering device 102.

Examples of the network 104 by which the script rendering device 102 communicates with the prescriber device 106 at least include Mobile Communications (GSM) network, a code division multiple access (CDMA) network, 3rd Generation Partnership Project (3GPP), 3GPP Long Term Evolution (LTE) network, an Internet Protocol (IP) network, a Wireless Application Protocol (WAP) network, a WiFi network, or an IEEE 802.11 standards network, as well as various combinations thereof. Other conventional and/or later developed wired and wireless networks may also be used.

In the system 100, the script rendering device 102 communicates with the prescriber device 106 to enable a prescriber to have an electronic script to be issued for an over-the-counter medication on behalf of a participant of a savings account. In general, the prescriber operating the prescriber device 106 is a person that is able to write a prescription for a medication on behalf of a participant. Examples of prescribers include doctors and nurse practitioners. In some embodiments, the prescribers may be part of a physician network. For example, the physician network may be able to obtain legally valid scripts in one or more of the states or other geographic regions. The prescriber may use the prescriber device 106 to review information received about a participant and approve the participant to have an electronic script for a medication. In general, the electronic script is for a particular participant. However, in some embodiments the electronic script may be for a group of people (e.g., a family).

The electronic scripts, once rendered, may be available for download from the script rendering device 102, may be transmitted or otherwise sent to the medication distributor device 110 where the participant or other person is to purchase the over-the-counter medication, may be sent to the participant or other person for whom the electronic script has been rendered, or may otherwise be used.

The prescriber device 106 may be associated with a single prescriber, or multiple prescribers. A prescriber may use a single prescriber device or multiple prescriber devices. In some embodiments, the script rendering device 102 may select prescribers to receive information on a single participant or multiple participants. The prescribers review the information and determine whether to have an electronic script generated for the participants.

The account management device 108 may be used by an account manager to manage tax-advantaged accounts on behalf of participants. Example tax-advantaged accounts include a flexible spending account (FSA), a health savings account (HSA), and a health reimbursement account (HRA). An FSA allows an employee to set aside a portion of his or her earnings to pay for qualified expenses (e.g., medical expenses) as established in the cafeteria plan. An HSA is a tax-advantaged medical savings account available to taxpayers in the United States who are enrolled in a High Deductible Health Plan (HDHP). An HRA allows employers to fund individual reimbursement accounts for their employees and define what those funds can be used for (e.g., specified out-of-pocket expenses such as deductibles and co-pays). Unused funds in the HRA can be rolled into future years for reimbursement, HRAs may be offered in conjunction with other employer-provided health benefits including FSAs, and Employees do not have to be covered under any other health care plan to participate.

In the system 100, when the account management device 108 receives an electronic script associated with an over-the-counter medication or notification of the electronic script with the over-the-counter medication, the account management device 108 may authorize payment processing for the over-the-counter medication from a tax-advantaged account associated with the participant and/or transfer funds for the over-the-counter medication from a tax-advantaged account associated with the participant to a personal account associated with the participant. The account management device 108 may automatically authorize the payment processing and/or funds transfer, or may do so upon the approval of the account manager or a person associated with the account manager.

In some embodiments, receipt of the electronic script or notification of the electronic script enables the account management device 108 to perform auto-substantiation for the participant so that the participant will not have to submit a receipt for the over-the-counter medication. Thus, in some embodiments, auto-substantiation includes automatically verifying the eligibility of an expense. When the account management device 108 receives a record of the transaction from a payment network, the account management device 108 may match the saved electronic script to the record of the transaction to ensure that the participant does not have to submit a receipt.

The medication distributor device 110 is a device operated by a medication distributor. The medication distributor may be a pharmacy, a grocery store, an online store, or another type of store that is capable of fulfilling an order of the over-the-counter medication on behalf of the participant. In the system 100, when the medication distributor receives an electronic script, the medication distributor is able to process the purchase of the over-the-counter medication on behalf of the participant.

The processing network device 112 is a device operated by a processing network. The medication distributor device 110 may be in communication with the processing network device 112 to facilitate payment from the tax-advantaged account of a participant and/or to verify that a certain product would qualify as being tax-advantaged. An example of a processing network is inventory information approval system (IIAS).

The benefit manager device 114 is a device operated by an entity at least partially responsible for creation and/or management of the pharmacy benefit. While the benefit manager operating the benefit manager device 114 is typically a PBM, other entities may operate the benefit manager device 114 either on behalf of themselves, the PBM, or another entity.

Some of the operations of a PBM that, in some embodiments, operates the benefit manager device 114 may include the following. A member (or a person on behalf of the member) attempts to obtain a prescription drug at a retail pharmacy location where the member can obtain drugs in a physical store from a pharmacist or pharmacist technician, or in some instances through mail order drug delivery from a mail order pharmacy location.

The member may have a co-pay for the prescription drug that reflects an amount of money that the member is responsible to pay the pharmacy for the prescription drug. The money paid by the member to the pharmacy may come from the personal funds of the member, a HSA of the member or the member's family, a HRA of the member or the member's family, a FSA of the member or the member's family, or the like. An employer of the member may directly or indirectly fund or reimburse the member or an account of the member for the co-pay.

The amount of the co-pay paid by the member may vary by the benefit plan of the client with the PBM. The member's co-pay may be based on be a flat co-pay (e.g., $10), co-insurance (e.g., 10%), and/or a deductible (e.g., for first $500 of annual prescription drug spend) for certain prescription drugs, certain types of prescription drugs, and/or all prescription drugs.

In certain instances, the member may not pay the co-pay or may only pay for a portion of a co-pay for a prescription drug. For example, if the usual and customary cost for a generic version of a prescription drug is $4, and the member's flat co-pay is $20 for the prescription drug, the member may only pay $4 to receive the prescription drug. In another example involving a worker's compensation claim, no co-pay may be due by the member for the prescription drug.

In conjunction with receiving the co-pay (if any) from the member and dispensing the prescription drug to the member, the pharmacy submits a claim to the PBM for the prescription drug. The PBM may perform certain adjudication functions including verifying the eligibility of the member, reviewing the formulary to determine appropriate co-pay, coinsurance, and deductible for the prescription drug, and performing a drug utilization review (DUR) on the member. The PBM then adjudicates the claim associated with the prescription drug and provides a response to the pharmacy following performance of the aforementioned functions. As part of the adjudication, the client (or the PBM on behalf of the client) ultimately reimburses the pharmacy for filling the prescription drug when the prescription drug was successfully adjudicated. The aforementioned adjudication functions generally occur before the co-pay is received and the prescription drug dispensed. However, the operations may occur simultaneously, substantially simultaneously, or in a different order. In addition, more or less adjudication functions may be performed as part of the adjudication process.

The amount of reimbursement paid to the pharmacy by the client and/or member may be based at least in part on the type of pharmacy network in which the pharmacy is included. Other factors may be used to determine the reimbursement amount in addition to the type of pharmacy network.

In some embodiments, the script rendering device 102 and the account management device 108 and/or the benefit manager device 114 are operated by a single entity. In other embodiments, the script rendering device 102 and the account management device 108 and/or the benefit manager device 114 are operated by different entities. In some embodiments, the script rendering device 102 and the account management device 108 and/or the benefit manager device 114 are jointly operated (e.g., on a single device or on a pool of devices), while in other embodiments, the client device 102 and the patient evaluator device 108 are separately operated.

Examples of the devices 102, 106, 108, 110, 112, 114 include a gaming unit, a mobile phone, a personal digital assistant (PDA), a display device, a generic or specialized computing system, or the like. Other devices may also be used. The devices 102, 106, 108, 110, 112, 114 may each use the same type of device, or may be different types of devices.

The script rendering device 102 may be in communication with a database 116. The database 116 may include questionnaire data 118, user data 120, and/or script data 122.

The questionnaire data 118 is used to generate questionnaires. The questionnaire data 118 may include a number of general and/or specific questions based on a particular product category in which the over-the-counter medication is associated.

The user data 120 may include health related information for various people including participants with a tax-advantaged savings account. These people may be in a health plan that is associated with an entity operating the script rendering device 102, or may otherwise have their information accessible to and/or stored by the entity. The user data 120 may include information about a single participant or multiple participants. The user data 120 may include, by way of example, a designation of a medical provider associated with a participant, a prescription drug history of a participant, or the like. In some embodiments, the user data 120 may include prescription drug claims data of the participant.

The script data 122 is used to generate an electronic script. The script data 122 may include, by way of example, an electronic signature associated with a prescriber.

The account management device 108 may be in communication with a management database 124. The management database 124 may store account data 126. The account data 126 is used to track the tax-advantaged account of the participant.

While the system 100 in FIG. 1 is shown to include single devices 102, 106, 108, 110, 112, 114, multiple devices may be used. The devices 102, 106, 108, 110, 112, 114 may be the same type of device or may be different device types. When multiple devices are present, the multiple devices may be of the same device type or may be a different device type. Moreover, system 100 shows a single network 104; however, multiple networks can be used. The multiple networks may communicate in series with each other to link the devices 102, 106, 108, 110, 112, 114 or in parallel to link the devices 102, 106, 108, 110, 112, 114.

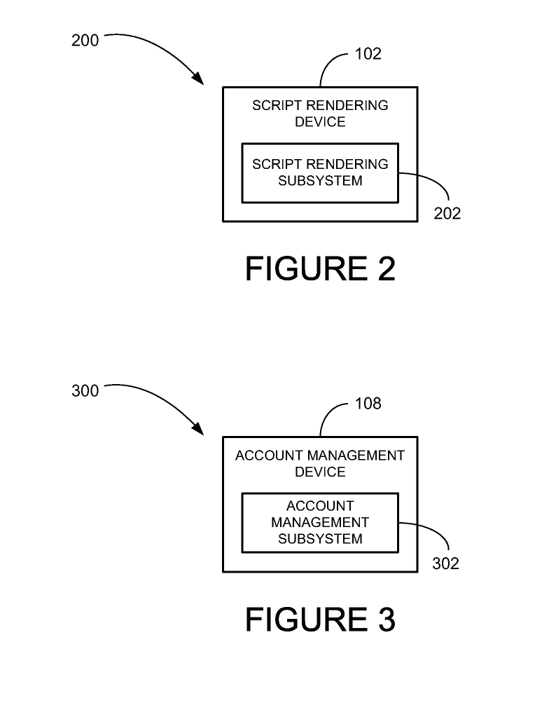

FIG. 2 illustrates the script rendering device 102, according to an example embodiment. The script rendering device 102 includes a script rendering subsystem 202. In general, the script rendering subsystem 202 enables an electronic script to be rendered for a participant to be able to purchase an over-the-counter medication from the participant's tax-advantaged account. The script rendering device 102 with the script rendering subsystem 202 may be deployed in the system 100, or may be deployed in another system.

FIG. 3 illustrates the account management device 108, according to an example embodiment. The account management device 108 includes an account management subsystem 302. In general, the account management subsystem 302 enables a medication distributor to manage a tax-advantaged account of a participant. The account management device 108 with the account management subsystem 302 may be deployed in the system 100, or may be deployed in another system.

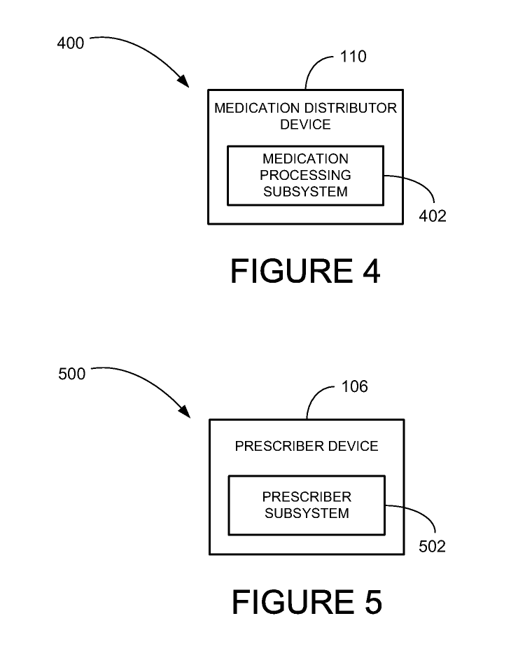

FIG. 4 illustrates the medication distributor device 110, according to an example embodiment. The medication distributor device 110 includes a medication processing subsystem 402. In general, the medication processing subsystem 402 enables a medication distributor to process an order of an over-the-counter medication on the basis of an electronic script. The medication distributor device 110 with the medication processing subsystem 402 may be deployed in the system 100, or may be deployed in another system.

FIG. 5 illustrates the prescriber device 106, according to an example embodiment. The prescriber device 106 includes a prescriber subsystem 502. In general, the prescriber subsystem 502 enables a provider to generate or approve the generation of an electronic script. The prescriber device 106 with the prescriber subsystem 502 may be deployed in the system 100, or may be deployed in another system.

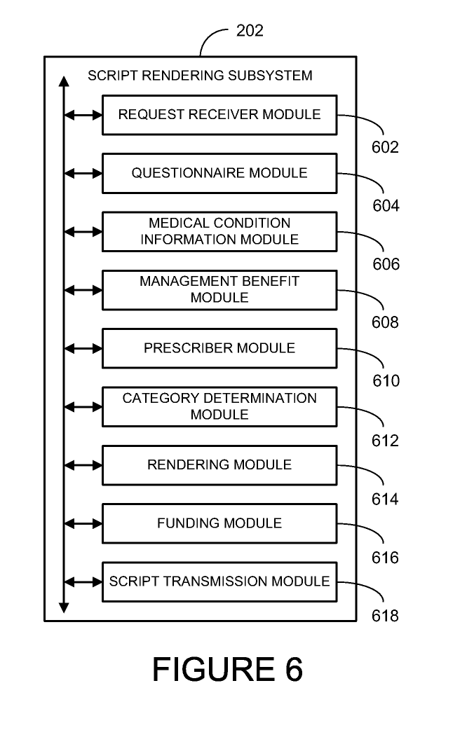

FIG. 6 illustrates an example script rendering subsystem 202 that may be deployed in the script rendering device 102, or otherwise deployed in another system. One or more modules are communicatively coupled and included in the script rendering subsystem 202 to enable rendering of an electronic script. The modules of the script rendering subsystem 202 that may be included are a request receiver module 602, a questionnaire module 604, a medical condition information module 606, a management benefit module 608, a prescriber module 610, a category determination module 612, a rendering module 614, a funding module 616, and/or a script transmission module 618. Other modules may also be included.

In some embodiments, the modules of the script rendering subsystem 202 may be distributed so that some of the modules are deployed in script rendering device 102 and some modules are deployed in the prescriber device 106, the account management device 108, the medication distributor device 110, the processing network device 112, and/or the benefit manager device 114. In one embodiment, the modules are deployed in memory and executed by a processor coupled to the memory. The functionality contained within the modules 602-618 may be combined into a lesser number of modules, further divided among a greater number of modules, or redistributed among existing modules. Other configurations including the functionality of the modules 602-618 may be used.

The request receiver module 602 is deployed in the script rendering subsystem 202 to receive a request. In general, the request is received from a participant requesting an over-the-counter medication. However, a different person acting on behalf of the participant may be able to make the request. The request may be for a specific over-the-counter medication (e.g., ROBITUSSIN DM) or for a category of over-the-counter medications (e.g., cough medicine).

Once the request is received, the questionnaire module 604 selects the questionnaire data 118 associated with an over-the-counter medication. The selected questionnaire data 118 is used to generate a questionnaire display including a single question or multiple questions based on the questionnaire data 118. In general, the questions are included in the questionnaire to enable a prescriber to approve the rendering of an electronic script for the over-the-counter medication. The questions may be specific for a particular over-the-counter medication, or may be general for a category of over-the-counter medication. Questions may be unique for certain over-the-counter medication and/or categories of over-the-counter medications or may be repeated for various over-the-counter medications and/or categories of over-the-counter medications.

The questionnaire module 604 then receives questionnaire response data. The questionnaire response data may be received from the participant that is requesting the over-the-counter medication or from a device associated with the participant. For example, the questionnaire response data may be received through a user interface generated by the script rendering device 102.

The participant seeking the over-the-counter medication may not have sufficient knowledge to request a particular over-the-counter medication or a category of over-the-counter medications. Thus, the medical condition information module 606 may be deployed in the script rendering subsystem 202 to receive medical condition information associated with a participant. For example, the medication condition information may include an identification of what ails the participant. The medical condition information module 606 may then identify the over-the-counter medication based on the medical condition information. The selection of the questionnaire data 118 by the questionnaire module 604 is then based on identification of the over-the-counter medication.

A management benefit module 608 may be deployed in the subsystem to identify possible drug interactions with the participant's existing over-the-counter and/or prescription medicines and a newly requested over-the-counter medicine. The management benefit module 608 may identify possible drug interactions by accessing the user data 120 associated with the participant including a prescription drug history of the participant and analyzing potential drug interactions for the participant based on the user data 120 and the over-the-counter medication. The management benefit module 608 may, in addition or alternatively, identify possible drug interactions by transmitting identification of the participant and the over-the-counter medication to the benefit manager device 114 and receives a drug interaction response (e.g., from the benefit manager device 114).

Once the questionnaire response data is received, the prescriber module 610 transmits a prescriber request to the prescriber device 106. The prescriber request is based on the questionnaire response data. In general, the prescriber request provides the prescriber with sufficient information to approve or disapprove of an electronic script for an over-the-counter medication.

The prescriber module 610 receives a prescriber response in response to transmission of the prescriber request. The prescriber response is generally received from the prescriber through use of the prescriber device 106. The prescriber response generally either indicates approval or disapproval of an electronic script or is a rendered electronic script.

The prescriber device 106 to which the transmission of the prescriber request is sent may depend on whether there is single prescriber device that one or multiple prescribers use or whether there are multiple prescriber devices (e.g., each of the multiple prescriber devices associated with a different prescriber).

When there are multiple prescriber devices, the prescriber module 610 may select the prescriber device 106 to receive the prescriber request from among available prescriber devices based on a geographic region (e.g., a state) associated with the participant. For example, a single prescriber may be licensed or otherwise authorized to write prescriptions for one or more states. The selection of the prescriber device 106 may then be on the basis of where the various prescribers can have the electronic script written on behalf of the participant.

Instead of or in addition to the geographic region, the selection of the prescriber device 106 among available prescriber devices may be based on the medication category (e.g., sore throat, stomach issues, etc.). For example, certain prescribers may have knowledge, expertise, or have some other basis or designation for being selected to evaluate prescriber requests for a medication category. In some embodiments, the category determination module 612 determines a medication category associated with the over-the-counter medication. The prescriber module 610 then selects the prescriber device 106 among available prescriber devices based on the medication category. The prescriber request may then be transmitted to the prescriber device 106 based on the selection of the prescriber device 106.

When the prescriber device 106 transmits a prescriber response that includes an approval, the rendering module 614 renders an electronic script associated with the over-the-counter medication. In general, the electronic script is associated with a single participant. However, the electronic script may be associated with multiple participants (e.g., persons in a same family).

The payment for the over-the-counter medication may be processed from a tax-advantaged account associated with the participant while the participant is making the purchase or after the purchase is made and the participant is seeking reimbursement of the purchase price from the tax-advantaged account.

The funding module 616 may be used to authorize payment processing for the over-the-counter medication from a tax-advantaged account associated with the participant. When authorized, the participant may make the purchase and the funding may come from the tax-advantaged account without the use of the participant's personal funds. Regardless of whether personal funds were initially used, the funding module 616 may be used to transmit funds for the over-the-counter medication. The funds can be transmitted from a tax-advantaged account to the medication distributor device 110 for payment, or may be used to reimburse the participant by transmitting the funds to a personal account associated with the participant.

The electronic script may be used electronically (e.g., by the participant), or may be printed in hard copy and brought to a medication distributor to purchase the over-the-counter medication. When used electronically, the script transmission module 618 may be used to transmit the electronic script to the medication distributor device 110.

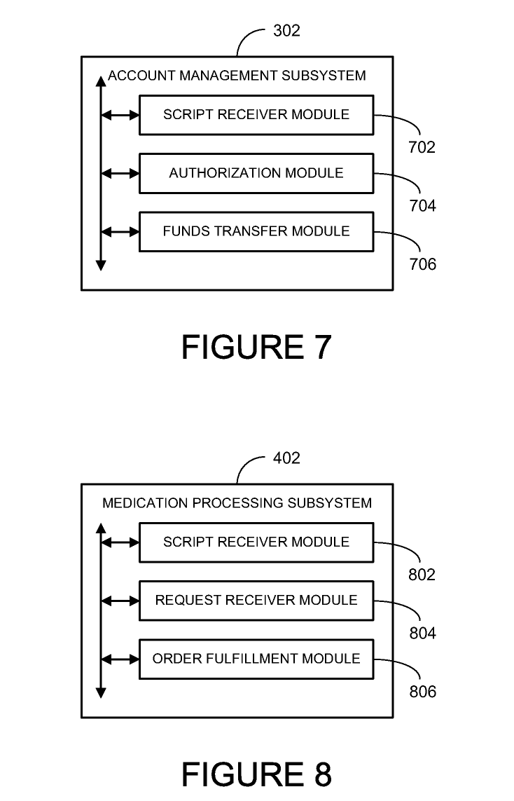

FIG. 7 illustrates an example account management subsystem 302 that may be deployed in the account management device 108, or otherwise deployed in another system. One or more modules are communicatively coupled and included in the account management subsystem 302 to facilitate payment or funding for an over-the-counter medication associated with an electronic script. The modules of the account management subsystem 302 that may be included are a script receiver module 702, an authorization module 704, and/or a funds transfer module 706. Other modules may also be included. In some embodiments, the modules of the account management subsystem 302 may be distributed so that some of the modules are deployed in the account management device 108 and some modules are deployed in the script rendering device 102, the prescriber device 106, the medication distributor device 110, the processing network device 112, and/or the benefit manager device 114. In one embodiment, the modules are deployed in memory and executed by a processor coupled to the memory.

The functionality contained within the modules 702-706 may be combined into a lesser number of modules, further divided among a greater number of modules, or redistributed among existing modules. Other configurations including the functionality of the modules 702-706 may be used.

The account management subsystem 302 may receive an electronic script associated with an over-the-counter medication through use of the script receiver module 702. The electronic script may be received from the script rendering device 102 or the prescriber device 106. Where the script was received from may depend on a particular implementation of the system 100 and the various devices 102, 106-114 and/or the capability of the devices 102, 106.

The authorization module 704, when deployed, authorizes payment processing for the over-the-counter medication from a tax-advantaged account associated with the participant when the electronic script is received. In some embodiments, the authorization module 704 may verify the source of the electronic script, the participant, or may otherwise make one or multiple verifications before authorizing payment.

The funds transfer module 706 transfers funds for the over-the-counter medication. The funds may be transferred from a tax-advantaged account associated with the participant to a personal account associated with the participant. This type of fund transfer may occur when the participant first pays for the over-the-counter medication with personal funds. The funds may be transferred to an account associated with the medication distributor device 110. The funds transfer may occur entirely electronically (e.g., through wire transfer) or may occur without at least entirely using electronics (e.g., through a paper check).

FIG. 8 illustrates an example medication processing subsystem 402 that may be deployed in the medication distributor device 110, or otherwise deployed in another system. One or more modules are communicatively coupled and included in the medication processing subsystem 402 to fulfill an order of over-the-counter medication. The modules of the medication processing subsystem 402 that may be included are a script receiver module 802, request receiver module 804, and/or an order fulfillment module 806. Other modules may also be included. In some embodiments, the modules of the medication processing subsystem 402 may be distributed so that some of the modules are deployed in the medication distributor device 110 and some modules are deployed in the script rendering device 102, the prescriber device 106, the account management device 108, the processing network device 112, and/or the benefit manager device 114. In one embodiment, the modules are deployed in memory and executed by a processor coupled to the memory.

The functionality contained within the modules 802-806 may be combined into a lesser number of modules, further divided among a greater number of modules, or redistributed among existing modules. Other configurations including the functionality of the modules 802-806 may be used.

The script receiver module 802 receives an electronic script associated with an over-the-counter medication for the participant. The electronic script may be received from the script rendering device 102, the prescriber device 106, or may otherwise be received. For example, the participant may indicate to the script rendering device 102 (e.g., through a user interface) a medication distributor from where the participant will purchase the over-the-counter medication.

In some embodiments, the medication distributor may have a relationship with the entity associated with the script rendering device 102. The entities may coordinate together to provide a single sign-on opportunity for the participant to select or otherwise approve the over-the-counter medication for purchase after the electronic script is obtained. In one embodiment, medications listed as being available for purchase with the participant's tax-advantaged account are so indicated in the user interface.

Regardless of whether the medication distributor is in a single sign-on relationship, the request receiver module 804 receives a purchase request for the over-the-counter medication. When both the purchase request and the electronic script have been received for the over-the-counter medication, the order fulfillment module 806 fulfills an order of the over-the-counter medication on behalf of the participant. In some embodiments, the order fulfillment module 806 transmits a payment request to the account management device 108 associated with an account manager and receives a payment confirmation in response to transmission of the payment request.

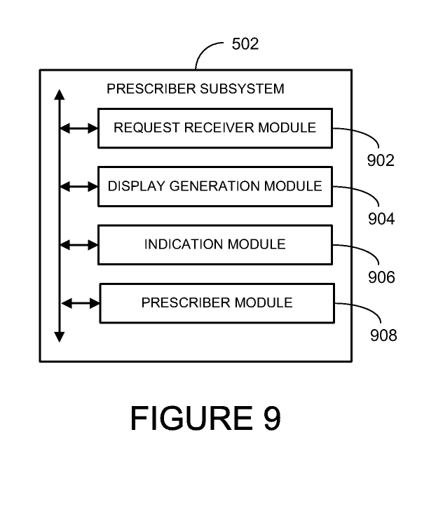

FIG. 9 illustrates an example prescriber subsystem 502 that may be deployed in the prescriber device 106, or otherwise deployed in another system. One or more modules are communicatively coupled and included in the prescriber subsystem 502 to enable a prescriber to have a prescription issued for an over-the-counter medication. The modules of the prescriber subsystem 502 that may be included are a request receiver module 902, a display generation module 904, an indication module 906, and/or a prescriber response module 908. Other modules may also be included. In some embodiments, the modules of the prescriber subsystem 502 may be distributed so that some of the modules are deployed in the prescriber device 106 and some modules are deployed in the script rendering device 102, the account management device 108, the medication distributor device 110, the processing network device 112, and/or the benefit manager device 114. In one embodiment, the modules are deployed in memory and executed by a processor coupled to the memory.

The functionality contained within the modules 802-806 may be combined into a lesser number of modules, further divided among a greater number of modules, or redistributed among existing modules. Other configurations including the functionality of the modules 902-908 may be used.

The request receiver module 902 receives a prescriber request. In general, the prescriber request is received from the script rendering device 102. However, if the participant is at the prescriber's office, the prescriber request can be received (e.g., orally) from the participant. The prescriber request may be based on the questionnaire response data and provides the prescriber with information to determine whether an electronic script should be issued for the over-the-counter medication.

The display generation module 904 generates a display based on the prescriber request. The display may enable the prescriber to approve or disapprove of electronic scripts one at a time or in bulk for multiple people.

The indication module 906 receives an approval indication or a disapproval indication from the prescriber. After the indication is received, the prescriber response module 908 transmits a prescriber response. In general, the prescriber response is provided to the device that made the request (e.g., the script rendering device 102). However, if no device originally made the request, the prescriber response as a default may be provided to the script rendering device 102.

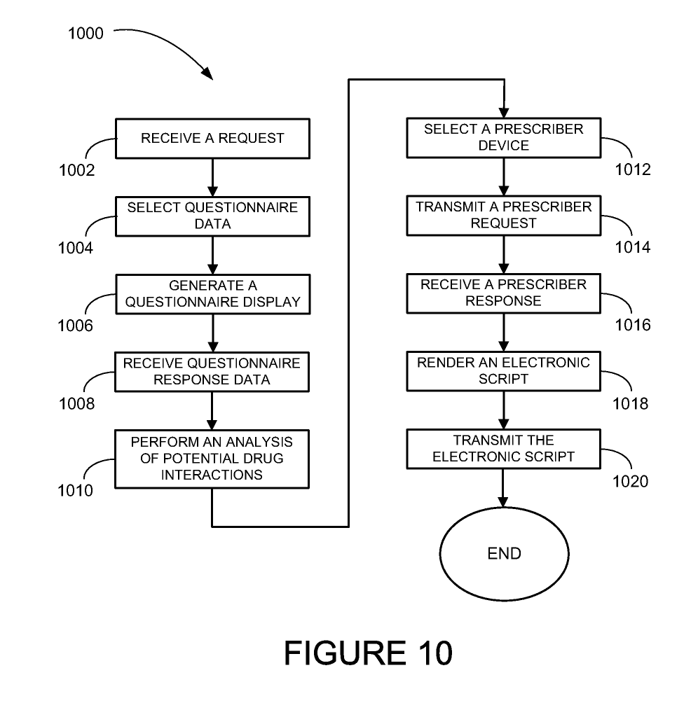

FIG. 10 illustrates a method 1000 for electronic script rendering according to an example embodiment. The method 1000 may be performed by the script rendering device 102, partially by the script rendering device 102 and partially by one or more of the other devices 106-114, or may otherwise be performed.

A request may be received at block 1002. In some embodiments, the request is an over-the-counter script request associated with an over-the-counter medication. The over-the-counter script request may be associated with a participant. In some embodiments, the request is a request for an over-the-counter medication.

The questionnaire data 118 associated with an over-the-counter medication is selected at block 1004. In some embodiments, the selection of the questionnaire data 118 is based identification of the over-the-counter medication.

In some embodiments, the medical condition information associated with a participant is received and the over-the-counter medication is identified based on the medical condition information. The questionnaire data 118 may then be selected based on the identification of the over-the-counter medication.

A questionnaire display including questions is generated at block 1006 based on the questionnaire data 118.

Questionnaire response data is received at block 1008. In some embodiments, the questionnaire response data may be received via a user interface from the participant, a person acting on behalf of the participant, or otherwise.

An analysis of potential drug interactions may be performed at block 1010. In some embodiments, the user data 120 associated with the participant is accessed and the potential drug interactions for the participant are analyzed based on the user data 120 and the over-the-counter medication.

In some embodiments, identification of the participant and the over-the-counter medication is transmitted to the benefit manager device 114 and a drug interaction response is received.

The prescriber device 106 may be selected at block 1012. The prescriber device 106 may be selected among available prescriber devices based on a geographic region associated with the participant. In some embodiments, a determination of a medication category associated with the over-the-counter medication may be made and the selection of the prescriber device 106 among available prescriber devices is based on the medication category.

In some embodiments, the user data 120 associated with the participant is accessed. The user data 120 may include a designation of a medical provider associated with the participant. The prescriber device 106 is then selected among available prescriber devices based on the designation of the medical provider associated with the participant.

A prescriber request is transmitted to the prescriber device 106 (e.g., as selected) at block 1014. The prescriber request may be based on the questionnaire response data.

A prescriber response is received in response to transmission of the prescriber request at block 1016.

At block 1018, an electronic script associated with the over-the-counter medication is rendered in response to receipt of the prescriber response. The electronic script may be associated with the participant.

The electronic script may be transmitted to the medication distributor device 110 at block 1020. The medication distributor associated with the medication distributor device may be capable of fulfilling an order of the over-the-counter medication on behalf of the participant.

In some embodiments, payment processing may be authorized for the over-the-counter medication from a tax-advantaged account associated with the participant.

In some embodiments, the funds for the over-the-counter medication are transmitted from a tax-advantaged account associated with the participant to a personal account associated with the participant.

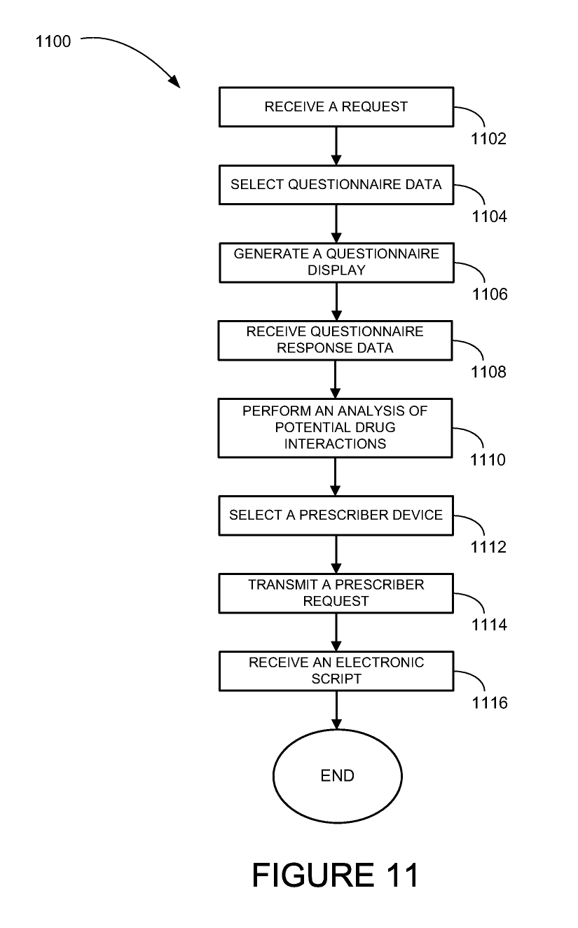

FIG. 11 illustrates a method 1100 for obtaining an electronic script according to an example embodiment. The method 1100 may be performed by the script rendering device 102, partially by the script rendering device 102 and partially by one or more of the other devices 106-114, or may otherwise be performed.

A request may be received at block 1102. In some embodiments, the request is an over-the-counter script request associated with an over-the-counter medication. The over-the-counter script request may be associated with a participant. In some embodiments, the request is a request for an over-the-counter medication.

The questionnaire data 118 associated with an over-the-counter medication is selected at block 1104.

In some embodiments, the medical condition information associated with a participant is received and the over-the-counter medication is identified based on the medical condition information. The questionnaire data 118 may then be selected based on the identification of the over-the-counter medication.

A questionnaire display including questions based on the questionnaire data 118 is generated at block 1106.

Questionnaire response data is received at block 1108.

An analysis of potential drug interactions may be performed at block 1110. In some embodiments, the user data 120 associated with the participant is accessed and the potential drug interactions for the participant are analyzed based on the user data 120 and the over-the-counter medication.

The prescriber device 106 may be selected at block 1112. The prescriber device 106 may be selected among available prescriber devices based on a geographic region associated with the participant. In some embodiments, a determination of a medication category associated with the over-the-counter medication may be made and the selection of the prescriber device 106 among available prescriber devices is based on the medication category.

At block 1114, a prescriber request is transmitted to the prescriber device 106. The prescriber request may be based on the questionnaire response data.

At block 1116, an electronic script associated with the over-the-counter medication is received in response to transmission of the prescriber request. The electronic script may be associated with a participant.

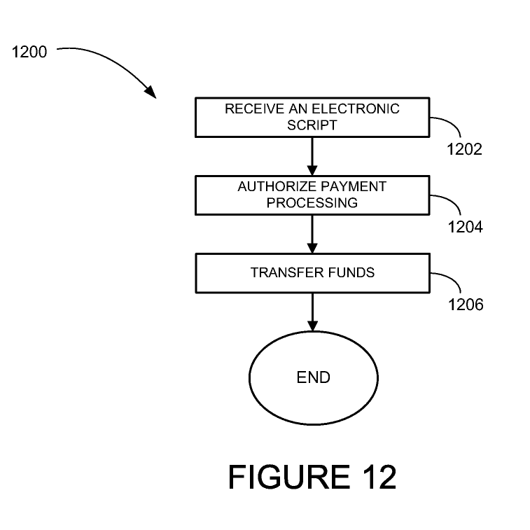

FIG. 12 illustrates a method 1200 for account management according to an example embodiment. The method 1200 may be performed by the account management device 108, or may otherwise be performed.

An electronic script associated with an over-the-counter medication is received at block 1202. The electronic script may be associated with a participant.

Payment processing for the over-the-counter medication may be authorized from a tax-advantaged account associated with the participant at block 1204.

Funds for the over-the-counter medication may be transferred from a tax-advantaged account associated with the participant to a personal account associated with the participant at block 1206.

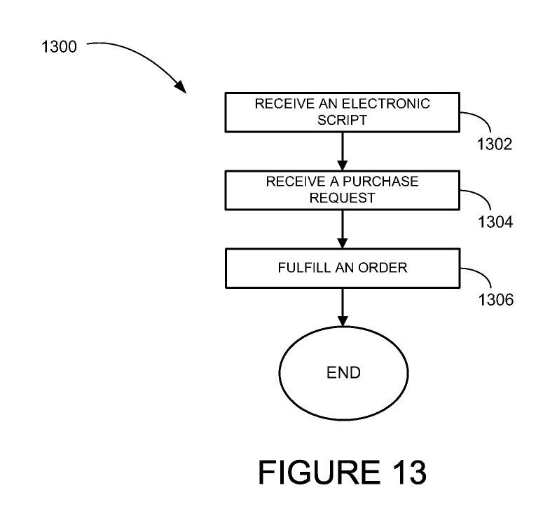

FIG. 13 illustrates a method 1300 for order fulfillment according to an example embodiment. The method 1300 may be performed by the medication distributor device 110, or may otherwise be performed.

An electronic script associated with an over-the-counter medication for a participant is received at block 1302.

A purchase request for the over-the-counter medication is received at block 1304. The purchase request may be associated with the participant.

At block 1306, an order of the over-the-counter medication is fulfilled on behalf of the participant based on receipt of the electronic script and the purchase request. In some embodiments, fulfilling the order includes transmitting a payment request to an account management device associated with an account manager and receiving a payment confirmation in response to transmission of the payment request.

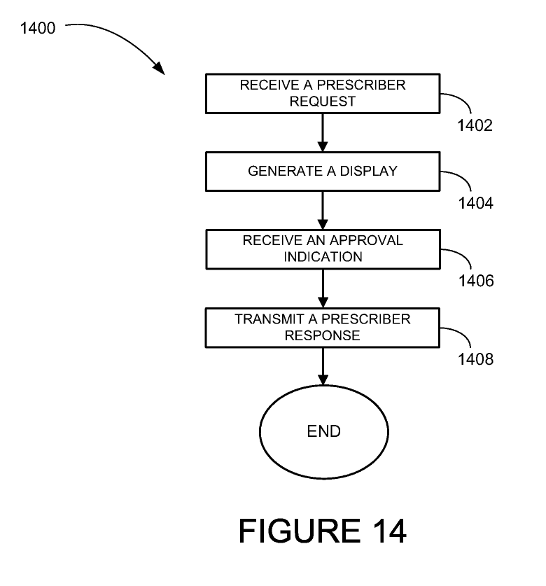

FIG. 14 illustrates a method 1400 for receiving a prescriber approval according to an example embodiment. The method 1400 may be performed by the prescriber device 106, or may otherwise be performed.

A prescriber request is received at block 1402. In some embodiments, the prescriber request is received from a pool of available prescriber requests.

A display is generated based on the prescriber request at block 1404.

An approval indication is received from a prescriber at block 1406.

At block 1408, a prescriber response is transmitted in response to receipt of the prescriber request based on receipt of the approval indication.

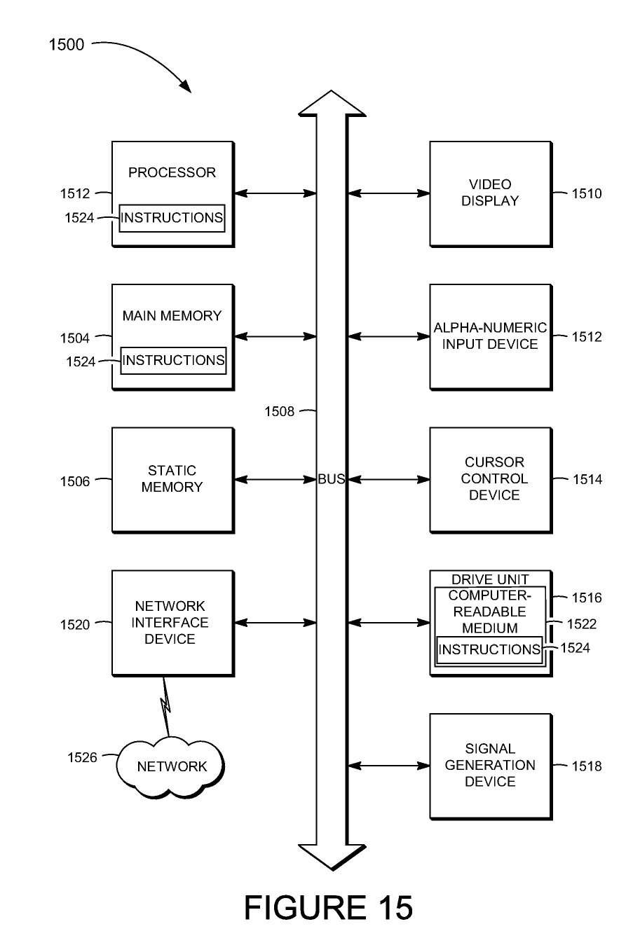

FIG. 15 shows a block diagram of a machine in the example form of a computer system 1500 within which a set of instructions may be executed causing the machine to perform any one or more of the methods, processes, operations, or methodologies discussed herein. The script rendering device 102, the prescriber device 106, the account management device 108, the medication distributor device 110, the processing network device 112, and/or the benefit manager device 114 may include the functionality of the one or more computer systems 1500.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1512 (e.g., a central processing unit (CPU) a graphics processing unit (GPU) or both), a main memory 1504 and a static memory 1506, which communicate with each other via a bus 1508. The computer system 1500 may further include a video display unit 1150 (e.g., a liquid crystal display (LCD) or a cathode ray tube (CRT)). The computer system 1500 also includes an alphanumeric input device 1512 (e.g., a keyboard), a cursor control device 1514 (e.g., a mouse), a drive unit 1516, a signal generation device 1518 (e.g., a speaker) and a network interface device 1520.

The drive unit 1516 includes a computer-readable medium 1522 on which is stored one or more sets of instructions (e.g., software 1524) embodying any one or more of the methodologies or functions described herein. The software 1524 may also reside, completely or at least partially, within the main memory 1504 and/or within the processor 1512 during execution thereof by the computer system 1500, the main memory 1504 and the processor 1512 also constituting computer-readable media. In some embodiments, the computer-readable medium 1522 is a non-transitory computer-readable medium.

The software 1524 may further be transmitted or received over a network 1526 via the network interface device 1520.

While the computer-readable medium 1522 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing or encoding a set of instructions for execution by the machine and that cause the machine to perform any one or more of the methodologies of the present invention. The term “computer-readable medium” shall accordingly be taken to include, but not be limited to, solid-state memories, and optical media, and magnetic media.

The terms “based on” or “using”, as used herein, reflects an open-ended term that can reflect others elements beyond those explicitly recited.

Certain systems, apparatus, applications or processes are described herein as including a number of modules. A module may be a unit of distinct functionality that may be presented in software, hardware, or combinations thereof. When the functionality of a module is performed in any part through software, the module includes a computer-readable medium. The modules may be regarded as being communicatively coupled.

The inventive subject matter may be represented in a variety of different embodiments of which there are many possible permutations.

In an example embodiment, questionnaire data associated with an over-the-counter medication is selected. A questionnaire display including a plurality of questions based on the questionnaire data is generated. Questionnaire response data is received. A prescriber request is transmitted to a prescriber device. The prescriber request is based on the questionnaire response data. The prescriber device is associated with a prescriber. A prescriber response is received in response to transmission of the prescriber request. An electronic script associated with the over-the-counter medication is rendered in response to receipt of the prescriber response.

In an example embodiment, questionnaire data associated with an over-the-counter medication is selected. A questionnaire display including a plurality of questions is generated based on the questionnaire data. Questionnaire response data is received. A prescriber request is transmitted to a prescriber device. The prescriber request is based on the questionnaire response data. The prescriber device is associated with a prescriber. An electronic script associated with the over-the-counter medication is received in response to transmission of the prescriber request.

In an example embodiment, an electronic script associated with an over-the-counter medication is received. The electronic script is associated with a participant. Payment processing is authorized for the over-the-counter medication from a tax-advantaged account associated with the participant.

In an example embodiment, an electronic script associated with an over-the-counter medication is received. The electronic script is associated with a participant. Funds for the over-the-counter medication are transferred from a tax-advantaged account associated with the participant to a personal account associated with the participant.

In an example embodiment, an electronic script associated with an over-the-counter medication for a participant is received. A purchase request for the over-the-counter medication is received. The purchase request is associated with the participant. An order of the over-the-counter medication is fulfilled on behalf of the participant based on receipt of the electronic script and the purchase request.

In an example embodiment, a prescriber request is received. The prescriber request is based on the questionnaire response data. A display is generated based on the prescriber request. An approval indication is received from a prescriber. A prescriber response is transmitted in response to receipt of the prescriber request based on receipt of the approval indication.

Thus, methods and systems for electronic script usage have been described. Although embodiments of the present invention have been described with reference to specific example embodiments, it will be evident that various modifications and changes may be made to these embodiments without departing from the broader spirit and scope of the embodiments of the invention. Accordingly, the specification and drawings are to be regarded in an illustrative rather than a restrictive sense.

The methods described herein do not have to be executed in the order described, or in any particular order. Moreover, various activities described with respect to the methods identified herein can be executed in serial or parallel fashion. Although “End” blocks are shown in the flowcharts, the methods may be performed continuously.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

What is claimed is:

1. A method comprising:
selecting questionnaire data associated with an over-the-counter medication;
generating a questionnaire display including a plurality of questions based on the questionnaire data;
receiving questionnaire response data;
transmitting a prescriber request to a prescriber device, the prescriber request being based on the questionnaire response data, the prescriber device associated with a prescriber;
receiving a prescriber response in response to transmission of the prescriber request; and
rendering an electronic script associated with the over-the-counter medication in response to receipt of the prescriber response.

2. The method of claim 1, further comprising:
receiving an over-the-counter script request associated with the over-the-counter medication, the over-the-counter script request associated with a participant.

3. The method of claim 1, further comprising:
receiving a request for the over-the-counter medication,
wherein selection of the questionnaire data is based on receipt of the request.

4. The method of claim 1, further comprising:
receiving medical condition information associated with a participant; and
identifying the over-the-counter medication based on the medical condition information,
wherein selection of the questionnaire data is based on the identification of the over-the-counter medication.

5. The method of claim 1, further comprising:
determining a medication category associated with the over-the-counter medication; and
selecting the prescriber device among a plurality of available prescriber devices based on the medication category,
wherein transmitting the prescriber request to the prescriber device is based on selection of the prescriber device.

6. The method of claim 1, further comprising:
selecting the prescriber device among a plurality of available prescriber devices based on a geographic region associated with a participant,
wherein transmitting the prescriber request to the prescriber device is based on selection of the prescriber device.

7. The method of claim 1, further comprising:
accessing user data associated with a participant, the user data including a designation of a medical provider associated with the participant; and
selecting the prescriber device among a plurality of available prescriber devices based on the designation of the medical provider associated with the participant,
wherein transmitting the prescriber request to the prescriber device is based on the selection of the prescriber device.

8. The method of claim 1, wherein the electronic script is associated with a participant, further comprising:
authorizing payment processing for the over-the-counter medication from a tax-advantaged account associated with the participant.

9. The method of claim 1, wherein the electronic script is associated with a participant, further comprising:
transmitting funds for the over-the-counter medication from a tax-advantaged account associated with the participant to a personal account associated with the participant.

10. The method of claim 1, wherein the questionnaire data is associated with a participant, further comprising:
accessing user data associated with the participant, the user data including a prescription drug history of the participant; and
analyzing potential drug interactions for the participant based on the user data and the over-the-counter medication.

11. The method of claim 1, wherein the questionnaire data is associated with a participant, further comprising:
transmitting an identification of the participant and the over-the-counter medication to a benefit manager device, the benefit manager device associated with a pharmacy benefit manager capable of analyzing potential drug interactions for the participant based on the user data and the over-the-counter medication; and
receiving a drug interaction response.

12. The method of claim 1, wherein the electronic script is associated with a participant, further comprising:
transmitting the electronic script to a medication distributor device,
wherein a medication distributor associated with the medication distributor device is capable of fulfilling an order of the over-the-counter medication on behalf of the participant.

13. The method of claim 1, wherein the questionnaire data is associated with a specific over-the-counter medication.

14. The method of claim 1, wherein the questionnaire data is associated with a class of over-the-counter medications that includes the over-the-counter medication.

15. The method of claim 1, wherein the electronic script is associated with a specific over-the-counter medication.

16. The method of claim 1, wherein the electronic script is associated with a class of over-the-counter medications that includes the over-the-counter medication.

17. A method comprising:
selecting questionnaire data associated with an over-the-counter medication;
generating a questionnaire display including a plurality of questions based on the questionnaire data;
receiving questionnaire response data;
transmitting a prescriber request to a prescriber device, the prescriber request being based on the questionnaire response data, the prescriber device associated with a prescriber; and
receiving an electronic script associated with the over-the-counter medication in response to transmission of the prescriber request.

18. A method comprising:
receiving an electronic script associated with an over-the-counter medication for a participant;
receiving a purchase request for the over-the-counter medication, the purchase request associated with the participant; and
fulfilling an order of the over-the-counter medication on behalf of the participant based on receipt of the electronic script and the purchase request.

19. The method of claim 18, wherein fulfilling the order comprises:
transmitting a payment request to an account management device associated with an account manager, the account manager managing an account on behalf of the participant; and
receiving a payment confirmation in response to transmission of the payment request.

20. A non-transitory machine-readable medium comprising instructions, which when executed by one or more processors, cause the one or more processors to perform the following operations:
select questionnaire data associated with an over-the-counter medication;
generate a questionnaire display including a plurality of questions based on the questionnaire data;
receive questionnaire response data;
transmit a prescriber request to a prescriber device, the prescriber request being based on the questionnaire response data, the prescriber device associated with a prescriber;
receive a prescriber response in response to transmission of the prescriber request; and
render an electronic script associated with the over-the-counter medication in response to receipt of the prescriber response.

21. A system comprising:
a processor and a memory coupled to the processor;
a questionnaire module deployed in the memory and executed by the processor to select questionnaire data associated with an over-the-counter medication, generate a questionnaire display including a plurality of questions based on the questionnaire data, and receive questionnaire response data;
a prescriber module deployed in the memory and executed by the processor to transmit a prescriber request to a prescriber device, the prescriber request being based on the questionnaire response data received by the questionnaire module, the prescriber device associated with a prescriber and receive a prescriber response in response to transmission of the prescriber request; and
a rendering module deployed in the memory and executed by the processor to render an electronic script associated with the over-the-counter medication in response to receipt of the prescriber response by the prescriber module.
